(19) United States
(12) Patent Application Publication
(10) Pub. No.: US 2015/0027941 A1
(43) Pub. Date: Jan. 29, 2015

(54) PORTABLE SEWAGE COLLECTION SYSTEM

(71) Applicant: MINEBAY PTY LTD, Newcastle, New South Wales (AU)

(72) Inventors: Bruce White, Kingscliff (AU); Graham Kent Amedee Paver, Coal Point (AU)

(21) Appl. No.: 14/354,076

(22) PCT Filed: Oct. 24, 2012
(86) PCT No.: PCT/AU2012/001300

§ 371 Date: Apr. 24, 2014

(30) Foreign Application Priority Data
Oct. 24, 2011 (AU) 2011904396

(51) Int. Cl. C02F 3/02; A47K 11/02

(52) U.S. Cl. CPC C02F 3/02; A47K 11/02; C02F 2103/005
USPC 210/209; 210/251; 4/479

(57) ABSTRACT

A portable sewage collection system comprising a cubicle with a flushing toilet and a sewage processing system. The sewage processing system is arranged to extract liquid effluent with low turbidity, wherein a portion of the liquid effluent is recycled and used as the flush liquid for the flushing toilet. The sewage collection system being powered by compressed air and being particularly suitable for use in remote locations such as underground mines. The cubicle includes a light that can be activated by a switch to provide light within the cubicle and the cubicle also including a deodorising spray to spray a deodorant into the cubicle to provide a pleasant smell.

### FIELD OF THE INVENTION

The present invention relates to a portable sewage collection system and in particular to a portable sewage collection system for underground mines.

However, it will be appreciated that the invention is not limited to this particular field of use.

### BACKGROUND OF THE INVENTION

There are many locations that are frequented by people for work or leisure reasons that often do not have any sort of sewage collection systems or toilets. Some examples of such locations are underground mines, construction sites, camp grounds and so on.

Portable toilets are commonly used in such locations. These portable toilets or outhouses hold only a limited amount of sewage and thus must be emptied frequently. In the context of an underground mine, odour and sewage disposal pose serious problems. Hauling sewage to the surface for disposal is both expensive and time-consuming. Portable composting toilets utilize a holding tank to store and process human sewage. (“Composting” means the microbial decomposition of organic matter.) Typically, these portable composting toilets use a biological organism, such as bacteria to decompose the human sewage in order to reduce both the amount of sludge that has to be hauled to the surface and the frequency with which the toilet has to be emptied.

However, current composting toilets suffer from a number of shortcomings. One such shortcoming is that conventional portable composting systems require daily maintenance because the composting material must be “flipped”, usually by a manually operated drum on a daily basis, in order to maintain efficient bacterial breakdown of the human sewage.

Furthermore, these portable toilets are typically constructed of plastics which have a propensity to develop surface micro-cracks which become repositories for sewage matter. Using disinfectants to clean the toilet has the unfortunate side-effect of destroying or at least substantially diminishing the biological breakdown process.

Portable toilets used in underground mines are often very small due to the confined space in underground mines and do not have any walls or a roof. They are often simply a composting tank with a toilet seat positioned above the composting tank. This can be problematic due to lack of privacy which can make this type of toilet unsuitable for users especially women. Such prior art toilets are also not emptied on a regular basis since mine toilets are only emptied when the mine is serviced. This can lead to an accumulation of the sewage material in the collection tank. The accumulated sewage can lead to bad odours making use of the prior art toilets unpleasant. The accumulated sewage in the collection tank also increases the hygiene risk due to accumulated untreated sewage. The prior art toilets as described are also a health risk because of splash back of untreated sewage from the toilet as a person uses the toilet.

### SUMMARY OF THE INVENTION

The present invention is directed to a sewage collection system that is adapted for use in underground mines. In particular in an embodiment the sewage collection system comprises a flushing toilet within an enclosed cubicle and a sewage digestion system that is arranged to digest solid sewage and sterilise the liquid effluent that is part of the collected sewage. The liquid effluent is recycled and used as the flush liquid in the flushing toilet.

In accordance with a first aspect, the present invention provides a sewage collection system comprising a sewage digester arrangement for receiving and digesting sewage, the sewage digester arrangement being air operated.

In an embodiment the sewage digester arrangement comprises a collection tank arranged to collect the sewage, the collection tank including a biological organism or a radiation device present in the tank in order to digest the collected sewage, the digester arrangement being an aerobic digester arrangement.

In an embodiment the system comprises one or more aeration units arranged to introduce air into the tank and the collected sewage in order to agitate the sewage and facilitate faster digestion.

In an embodiment the system comprises one or more filter media to filter liquid from sewage.

In an embodiment the system comprising a plurality of treatment tanks, the treatment tanks arranged to receive sewage from the collection tank, the treatment tanks arranged to process sewage to extract effluent.

In an embodiment sewage is transmitted from one treatment tank to the next treatment tank in order to process the sewage to extract effluent.

In an embodiment each treatment tank comprises either a heat or radiation treatment device to treat sewage in the treatment tank.

In an embodiment any one or more of the collection tank or treatment tanks comprises a sloping bottom, the sloping bottom being arranged to localise sewage or sludge.

In accordance with a second aspect, the present invention provides for a portable sewage collection system comprising a compartment for receiving a user and for mounting a toilet, the compartment being height adjustable.

In an embodiment the compartment comprises a roof, the roof or a section of the roof being height adjustable such that the roof or a section of the roof can be raised or lowered to facilitate access to various locations.

In accordance with a third aspect, the present invention provides for a portable sewage collection system, the system comprising an cubicle for receiving a user and for mounting a toilet, the system further comprising a digestion system arranged to receive sewage from the toilet and digest the sewage such that the system can be used without servicing or emptying for an extended period of time.

In an embodiment the sewage digestion system digesting the sewage such that servicing and emptying of sewage is not required for at least a year.

In accordance with a fourth aspect, the present invention provides a sewage collection system comprising a toilet and tanks for receiving sewage, the tanks and toilet being fire proof and anti static.

In accordance with a fifth aspect, the present invention provides a portable sewage collection system comprising a cubicle arranged to receive a user and for mounting a toilet, the cubicle comprising an explosion proof light.

In an embodiment the cubicle comprises or includes hook to receive a utility object from the user, the hook being connected to a load sensing circuit wherein the light being activated when a load is sensed on the hook. The utility object may be a utility belt or a helmet. The hook is connected to a sensor that activates an electricity generation system.

In an embodiment the portable sewage collection system comprises an electricity generation system, the electricity generation system comprising an air motor being connected to an alternator, the air motor turning the alternator to generate electricity.

In an embodiment the cubicle comprises an automatically activated deodoriser spray arranged to spray deodorant at timed intervals in order to deodorise the cubicle.

In accordance with a sixth aspect, the present invention providing a sewage collection system comprising a cubicle arranged to mount a toilet and receive a user, the cubicle comprising three walls and an openable door, the cubicle being fully enclosed once the door is closed in order to provide the toilet user privacy while using the toilet.

In an embodiment the system comprises a frame to enclose the cubicle, the frame comprising one or more removable panels forming one or walls.

In accordance with a seventh aspect, the present invention provides a sewage collection system comprising an cubicle for mounting a toilet and receiving a user, the floor of the cubicle being sloped and the edges of the cubicle being rounded.

In accordance with an eighth aspect, the present invention provides a portable sewage collection system comprising an cubicle for receiving a user, the cubicle being made from a fire proof, anti static fibre reinforced plastics material.

In accordance with a ninth aspect, the present invention provides a portable modular sewage collection system. The system being modular is advantageous because at least some parts of the system are able to be regularly serviced. The modular arrangement also allows replacement of parts of the system when required.

In accordance with a tenth aspect, the present invention provides a sewage collection system comprising a sewage processing system arranged to process sewage. In an embodiment the sewage processing system is arranged to digest sewage and extract water from the sewage.

In an embodiment the sewage processing system comprises at least one collection tank wherein the collection tank arranged to collect and digest sewage.

In an embodiment the sewage processing system comprising at least one treatment tank arranged to be in fluidic communication with the collection tank, the treatment tank arranged to receive liquid sewage from the collection tank, the treatment tank further arranged to process the liquid sewage to remove solids to generate effluent with low turbidity.

In an embodiment the collection tank or treatment tank comprising an aeration unit arrange to introduce air into either the collection tank or treatment tank in order to process sewage.

In an embodiment the sewage collection system is a closed system such that no effluent leaks out of the system.

In accordance with an eleventh aspect, the present invention provides a sewage collection system comprising a toilet arranged to be used by a user, the toilet comprising a flush system, the water from the flush system being recycled through the sewage processing system and reused by the flush system.

In accordance with one aspect, the present invention provides a sewage collection system comprising a sewage processing system arranged to receive sewage and digest at least solid sewage from the received sewage, the sewage processing system arranged to extract liquid effluent with minimal turbidity.

In accordance with one aspect, the present invention provides a portable sewage collection system comprising a plurality of walls defining a cubicle, a toilet pan disposed within the cubicle, the toilet pan being arranged to be flushed by a user to evacuate the sewage from the toilet pan, the system further comprising a sewage processing system that receives the evacuated sewage, the sewage processing system being arranged to extract liquid effluent, at least a portion of the liquid effluent being recycled and used to flush the toilet pan.

In an embodiment the sewage processing system comprises aerobic bacteria that assists to break down solid sewage and extract liquid sewage.

In an embodiment the system comprises a sterilising unit arranged to sterilise a portion of the liquid effluent prior to using the effluent to flush the toilet pan.

In an embodiment the sterilising unit comprises at least one UV tube that receives a portion of the liquid effluent to sterilise the liquid effluent.

In an embodiment the system comprises a compressed air circuit that is arranged to provide compressed air to move sewage or liquid effluent about the system.

In an embodiment the system comprising an air lift pump that is arranged to provide a volume of effluent to the sterilising unit, wherein the volume of effluent is small to ensure the flush volume is 1 litre or less.

In an embodiment the volume of sterilised effluent is low enough such that the aerobic bacteria is not killed due to excessive sterilised effluent. The low flush volume is also advantageous because it reduces the chances of splash back on to the user.

In an embodiment the cubicle comprises a deodorant spray, the deodorant spray being arranged to pneumatically operated and being arranged to spray a deodorant within the cubicle.

In an embodiment the system comprising a power generation means being arranged to generate electricity to activate the sterilising unit.

In an embodiment the power generation means comprises an air motor being connected to an alternator, the air motor being activated when the toilet pan is flushed, the air motor turning the alternator to generate electricity.

In an embodiment the system comprising component box, the component box arranged to be pressurised by compressed air, the component box being arranged to house any electrical components.

In an embodiment the toilet pan is connected to a venturi, the venturi being arranged to create a vacuum to evacuate the contents of the toilet pan. The venturi is activated for an extended period of time to ensure the sewage from the toilet pan is evacuated

In accordance with one aspect, the present invention provides a portable sewage collection system comprising a cubicle for receiving a user, a toilet pan being mounted within the cubicle, the cubicle providing privacy for a user.

In an embodiment the compartment comprises a roof, the roof or a section of the roof being height adjustable such that the roof or a section of the roof can be raised or lowered to facilitate access to various locations.

In an embodiment the cubicle comprises a light positioned within the cubicle, and an activation system, the activation system being arranged to activate the light.

In an embodiment the toilet pan is positioned at substantially ground level.

In an embodiment the toilet pan is positioned at 100 mm or less than 100 mm above ground level when in use.

In accordance with one aspect, the present invention provides a portable sewage collection system comprising a cubicle for receiving a user and for mounting a toilet pan, the system further comprising a sewage processing system arranged to receive sewage from the toilet pan and digest the sewage such that the system can be used without servicing or emptying for an extended period of time.

In accordance with one aspect, the present invention provides a sewage collection system comprising a flushing toilet and tanks for receiving sewage, the tanks and toilet being made from fire proof material.

In accordance with one aspect, the present invention provides a sewage collection system comprising a cubicle arranged to receive a user and for mounting a toilet, the cubicle comprising a light, wherein the light is activated by an activation system.

In accordance with one aspect, the present invention provides a sewage collection system comprising an cubicle arranged to mount a toilet and receive a user, the cubicle comprising three walls and an openable door, the cubicle being fully enclosed once the door is closed in order to provide the toilet user privacy while using the toilet.

### DETAILED DESCRIPTION OF THE DRAWINGS

Notwithstanding any other embodiments that may fall within the scope of the present invention, an embodiment of the present invention will now be described, by way of example only, with reference to the accompanying figures, in which:

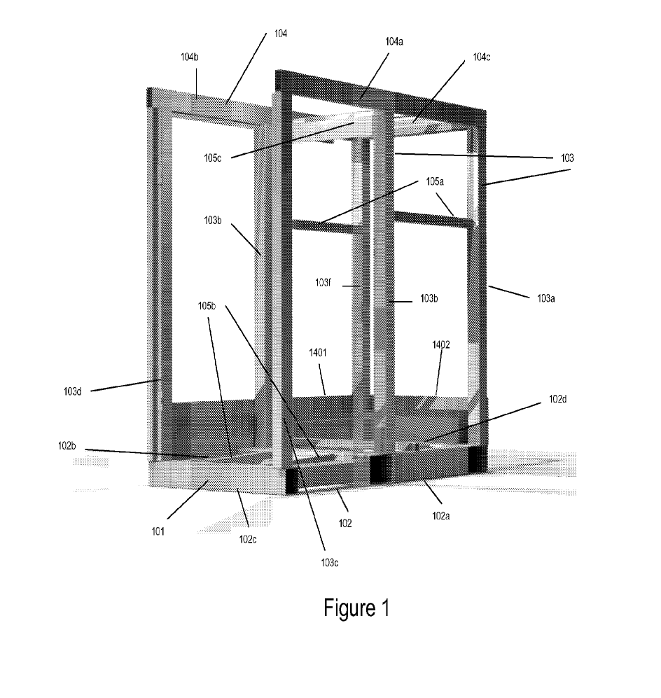

FIG. 1 shows a perspective view of the frame of a portable sewage collection system in accordance with the present invention;

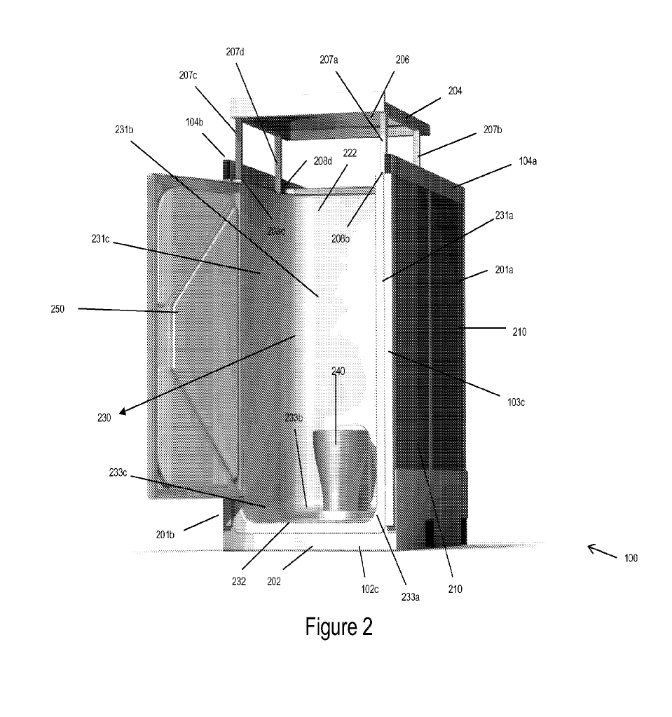

FIG. 2 shows a front on view of the portable sewage collection system in accordance with the present invention;

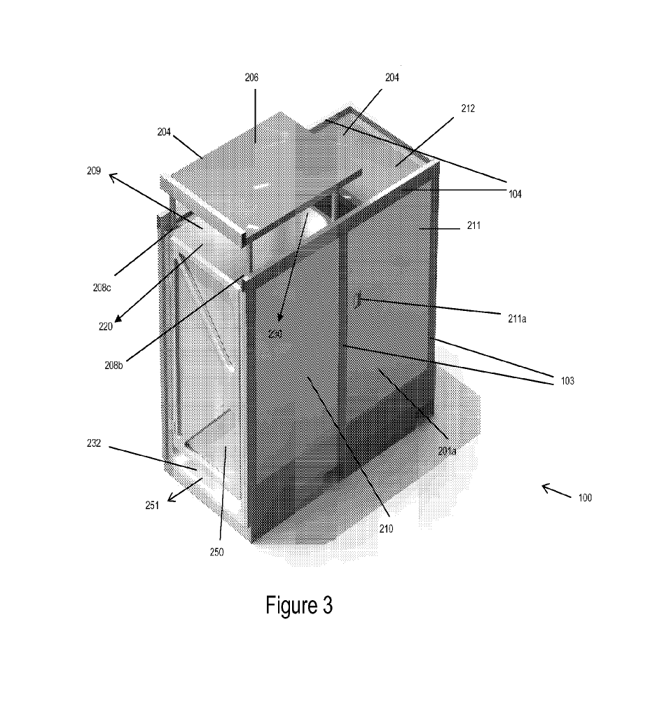

FIG. 3 shows a perspective view of the portable sewage collection system in accordance with the present invention;

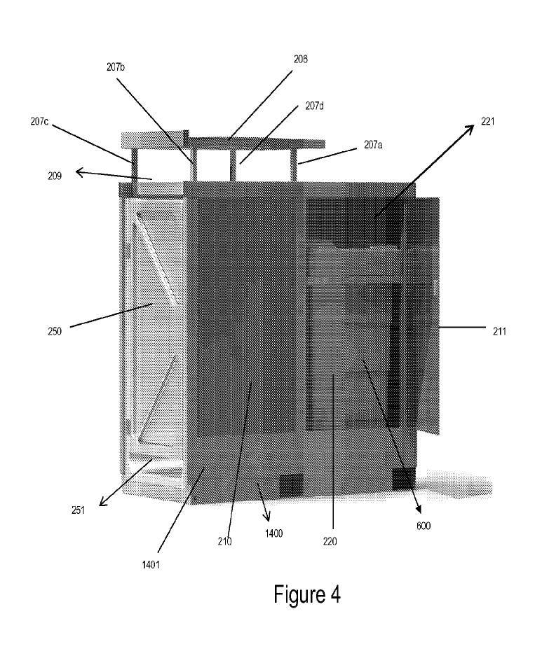

FIG. 4 shows a further perspective view of a collection tank housed within the portable sewage collection system in accordance with the present invention;

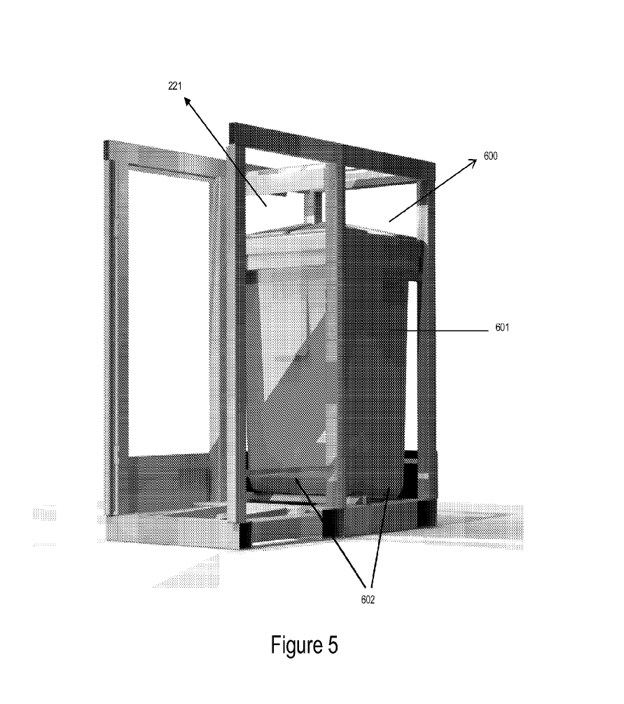

FIG. 5 shows a view of the frame and a collection tank that forms part of a sewage digestion system;

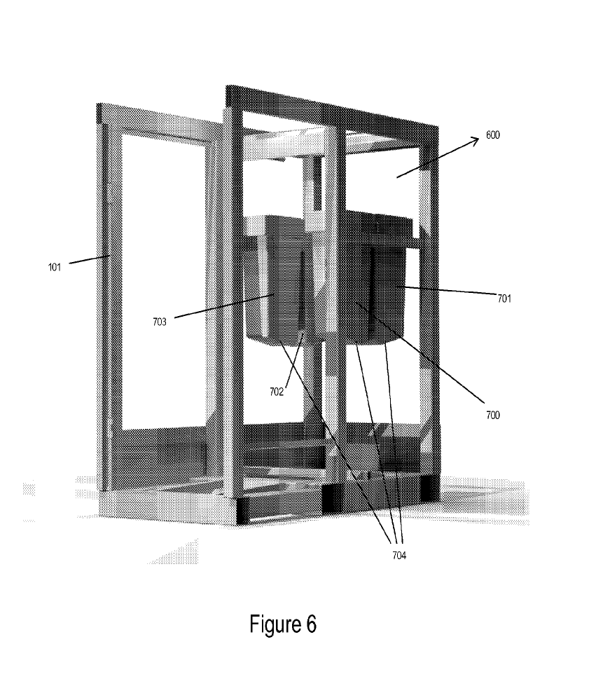

FIG. 6 shows a view of the frame and a plurality of treatment tanks that also form part of a sewage digestion system;

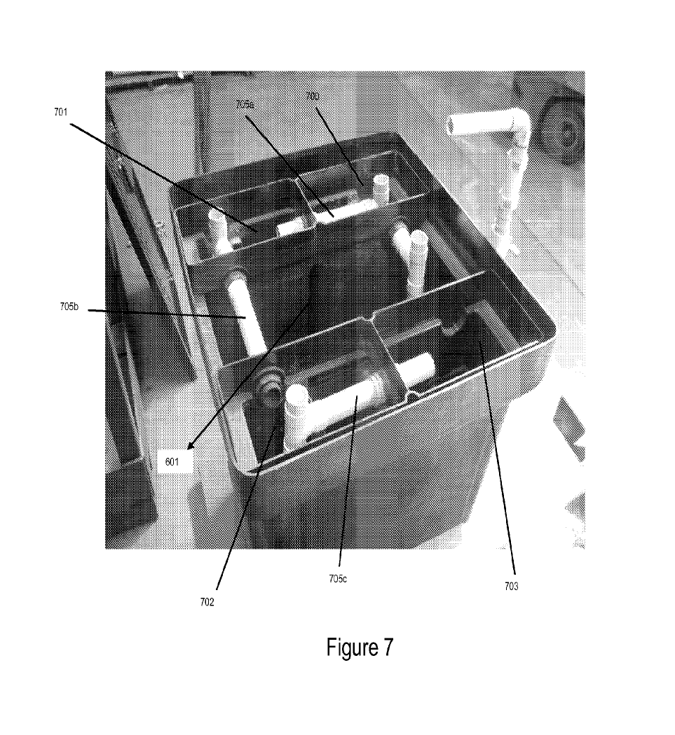

FIG. 7 shows a view of the sewage digestion system, in particular the arrangement of the collection tank, the treatment tanks and fluid connections between the treatment tanks;

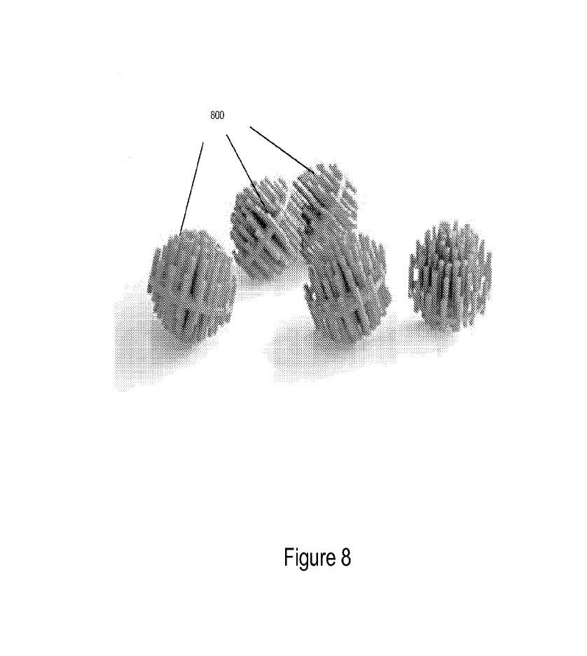

FIG. 8 shows a view of a plurality of growth structures that are used in the sewage digestion system to provide a surface for a biological organism to grasp and reproduce on;

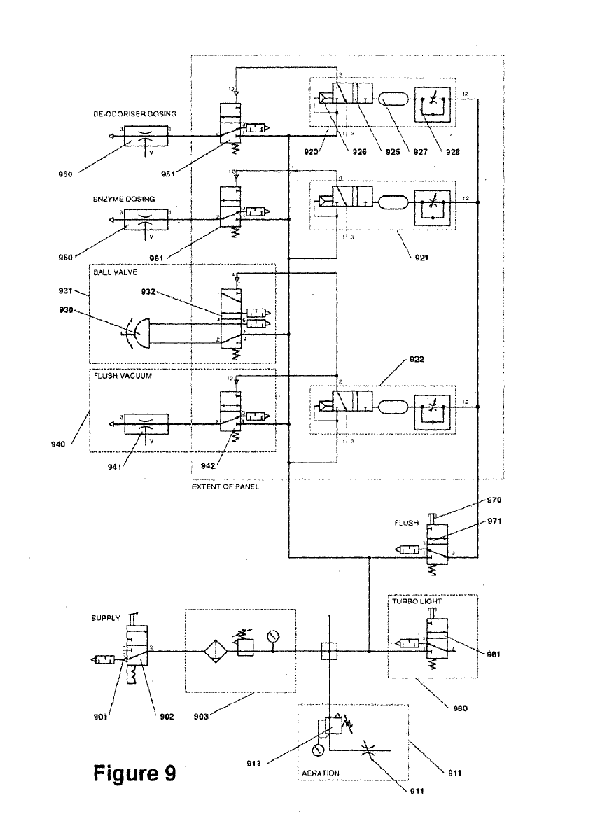

FIG. 9 shows a schematic diagram of one embodiment of a pneumatic circuit used as part of the portable sewage collection system in accordance with the present invention;

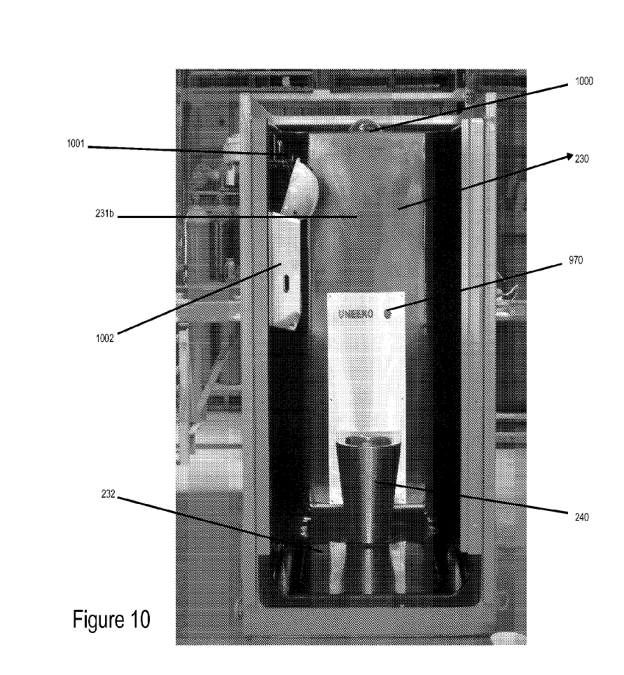

FIG. 10 shows a front on view of the portable sewage collection system including the load sensing hook, the load activated light and toilet paper holder;

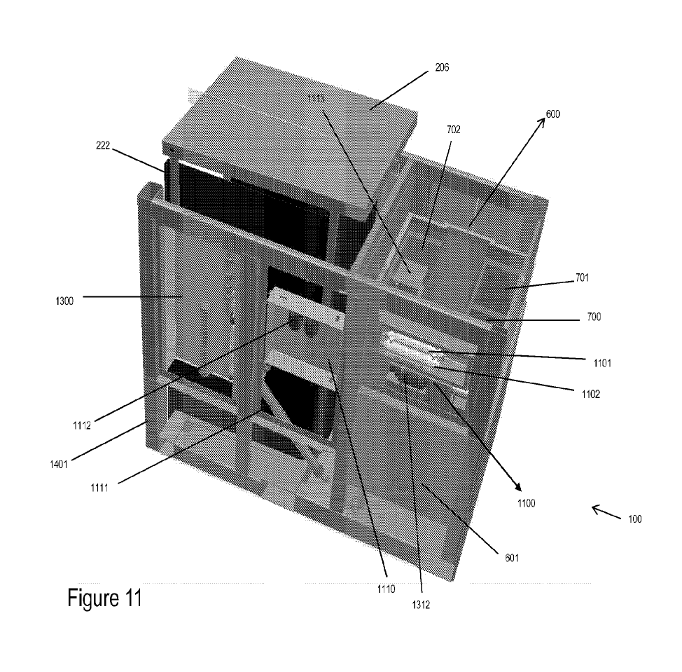

FIG. 11 shows a view of the sewage collection system with the sterilisation unit;

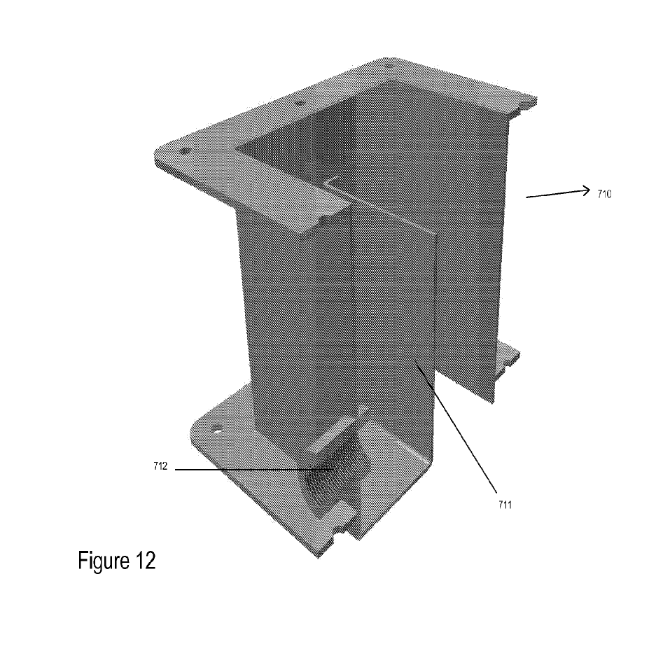

FIG. 12 shows a view of the reservoir used to supply the sterilisers and flush cistern with flush liquid; and

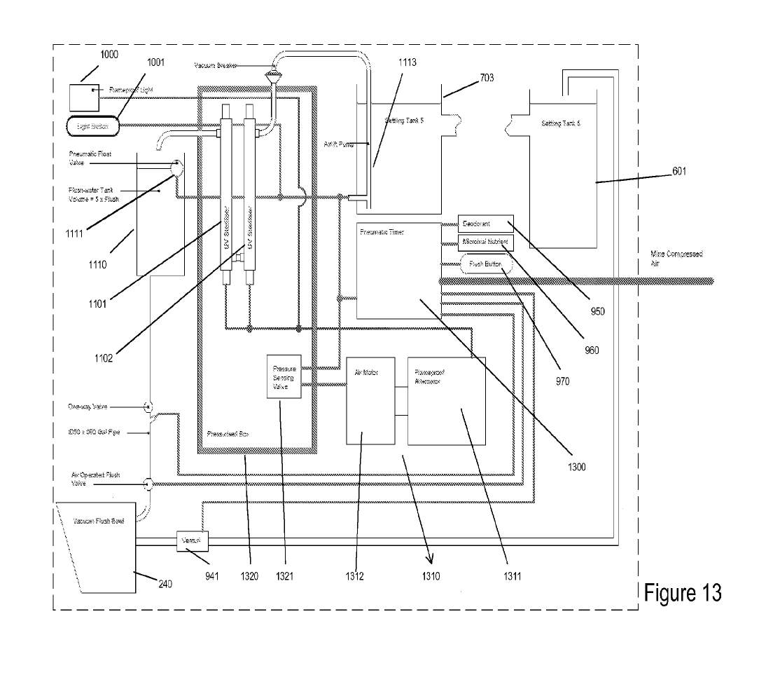

FIG. 13 shows a schematic diagram of the sewage collection system illustrating various components of the system.

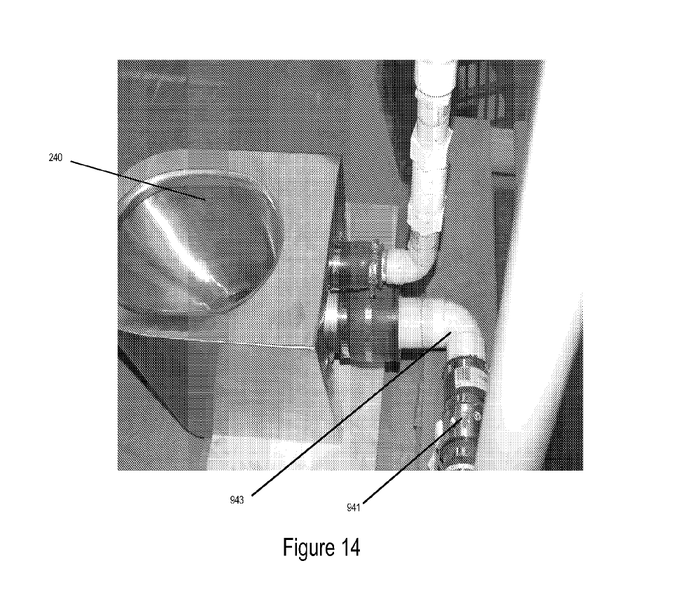

FIG. 14 shows a view of the toilet pan and the venturi.

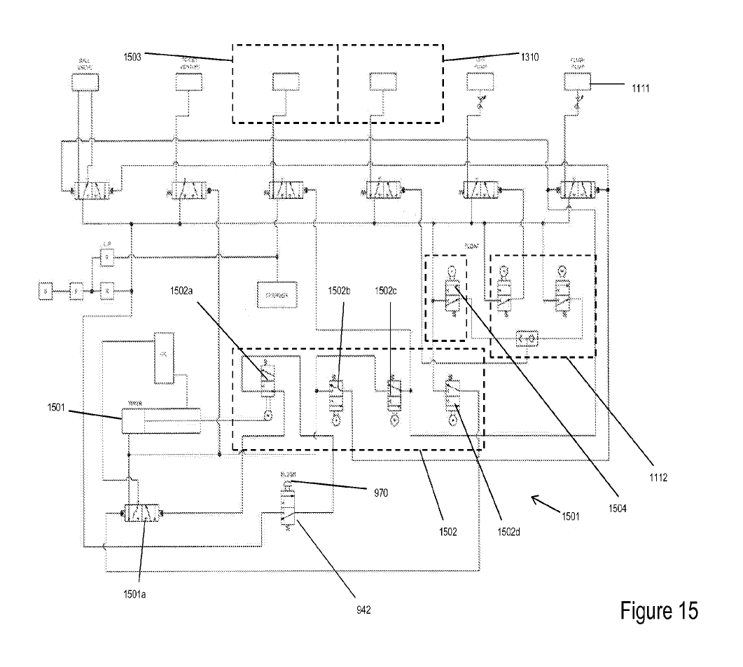

FIG. 15 shows a schematic diagram of a further embodiment pneumatic circuit that can be used as part of the sewage collection system.

### DESCRIPTION OF PREFERRED/SPECIFIC EMBODIMENTS

The present embodiment provides for a portable sewage collection system. The present invention is particularly arranged for sewage collection system. In the present specification sewage collection and sewage collection will be used interchangeably. In one embodiment the portable sewage collection system is in the form of a toilet system arranged to collect human sewage such as urine or stools or both. The portable sewage collection system is arranged collect sewage and human sewage and breakdown or digest the sewage. The portable sewage collection system also provides an enclosed area for a user to privately use the sewage collection system to go to the toilet.

The sewage collection system of this embodiment can be used in remote locations such as underground mines, camp grounds, construction sites, remote rest stops and so on. An embodiment of the present invention will be described with reference to underground mines. The sewage collection system is particularly useful for underground mines and is novel for use in underground mines. The sewage collection system is arranged to function as a toilet and toilet system. Underground mines such as coal mines or gold mines are remote locations where there are often no permanent toilet fixtures due to lack of sewer lines. Often portable toilets are used within these remote locations.

Underground mines often have minimal space in the mines. Therefore toilets used in underground mines need to be substantially compact to fit into the tight spaces. The commonly used portable toilets for underground mines are generally toilets that simply collect sewage in a collection tank or collection pit. These toilets often smell very bad and very unpleasant to use due to excessive bad smells. These toilets also need to be serviced regularly to remove the built up sewage because the sewage builds up quickly. For example these toilets need to be emptied every 3 months at least in order to keep the toilet in working order and to stop the toilets from overflowing. These collection type toilets are often in the form of an open toilet with no walls. For example, these portable toilets are a toilet seat positioned over a tank or pit. In order to use the toilet a user simply sits down on the seat and “does their business”. There is no privacy for the user and the user is subject to bad smells, making these prior art toilets unattractive and unpleasant to use. The prior art toilets are also a health and hygiene risk as they collect and maintain untreated sewage for extended periods of time. This collected untreated sewage can splash back as someone uses the toilet and can lead to infection.

The sewage collection system of the present invention is particularly advantageous as it seeks to ameliorate the problems with the prior or at least provide the public with a useful alternative. The portable sewage collection apparatus is powered entirely by compressed air. The sewage from the toilet bowl or pan is evacuated by a vacuum. The sewage is collected and treated using a combination or aeration by air bubbles and aerobic bacteria to digest or breakdown the sewage. The sewage collection system comprises a sewage processing system that is made up of a series of tanks that process the sewage resulting in processed black water or effluent. The effluent is treated using UV (ultra violet) sterilisers. The treated effluent is recycled and used in the flush cycle. In this specification effluent and treated black water have the same definition and can be used interchangeably. The sewage collection system further isolates the user from the collected sewage via at least one but preferably a plurality of barriers. The barriers are both physical barriers as well as the structure of the system that forces the user to interact with the system in a particular way to ensure the user is separated from the collected sewage. Example barriers are the collection tank that separates the user cubicle from the sewage. Further the user cubicle has at least one wall between the collection tank and the user. The flush button is positioned such that user has to stand up to press the flush button thus separating the user from the sewage collected in the toilet pan. The vacuum in the toilet remains operational for an extended period of time to ensure the sewage from the pan is evacuated.

The sewage collection system will be described in greater detail with respect to the accompanying figures. The sewage collection system 100 of the present invention will be described with respect underground mines and is particularly suitable for use in underground mines such as coal mines.

FIG. 1 shows a frame 101 of the portable sewage collection system 100. The frame 101 comprises a plurality of base frame 102. In one form the base frame 102 form a substantially rectangular shape. The base frame 102 comprises at least two longitudinal base members 102a, 102b, the two longitudinal base members 102a, 102b being parallel to each other. In another form the longitudinal base members may be in the form of multiple longitudinal members that extend parallel to each other.

The base frame 102 further comprises two transverse base members 102c, 102d. The transverse base members 102c, 102d are substantially perpendicular to the longitudinal base members 102a, 102b. In another form the base frame 102 may comprise a plurality of transverse members running parallel to each other. In yet another form the two base members 102a, 102b may comprise a plurality of base members. The longitudinal and transverse base members may be bolted or riveted together to form the rectangular base frame 102. In another form the longitudinal and transverse members may be welded together.

The frame 101 further comprises a plurality of vertical members 103. The vertical members 103 extend upward from the base frame 102. The vertical members 103 extend parallel to each other and substantially perpendicular to the base frame 102. The vertical members 103 may be bolted, riveted or welded to the base frame 102. In the illustrated form the frame 101 comprises six vertical members 103a, 103b, 103c, 103d, 103e and 103f. In other forms the frame 101 may comprise only four vertical members or three vertical members or any other suitable number of vertical members.

The frame 101 also comprises a roof frame 104. The roof frame 104 comprises a plurality of elongate members. The roof frame 104 comprises longitudinal members 104a, 104b and at least one transverse member 104c. The longitudinal members 104a, 104b of the roof frame are substantially parallel to the longitudinal members 102a, 102b. The transverse member 104c is substantially parallel to the transverse member 102d or 102c.

The frame 101 may also comprise additional cross members 105a extends between various vertical members. The frame 101 may also comprise cross members 105b that extend between the base frame 102. The frame 101 may also comprise cross members 105c that extend between the roof frame 104. The cross members 105a, 105b and 105c provide additional strength and rigidity to the frame 101. The sewage collection apparatus may comprise any number of cross members in any suitable arrangement to provide stiffness and rigidity to the frame 101.

The frame is made from a rigid, corrosion and stress resistant material. The frame 101 is made from a corrosion resistant material such that it can be used in underground mines such that the frame is not deteriorated by any potential corrosive materials such as sulphur or other chemicals that may come into contact with the frame or sewage collection apparatus. In one example the frame 101 is formed from galvanised steel. In another example aluminium can be used to construct the frame 101. However any other rigid, corrosion resistant material can be used. The rigid, corrosion resistant material such as galvanized steel is advantageous because the material makes the entire frame substantially wear resistant.

The portable sewage collection system comprises a plurality of walls that form an enclosed space. The walls are comprised of a plurality of panels that are attached to the frames. FIG. 2 shows a view of the portable sewage collection system with the plurality of walls. The system 100 comprises two side walls 201a, 201b and an end wall 201c (not illustrated). The end wall is the vertical wall that extends parallel to the side walls. The sewage collection system 100 also comprises a base wall 202, and a roof wall. The side walls, end walls, base wall and roof are comprised of one or more panels. In the illustrated example, each side wall 201a or 201b comprise two panels 210, 211. The panels 210, 211 are removably attached to the vertical members of the frame 101. The panels 210, 211 are bolted on to the frame. In other forms the panels 210, 211 may be riveted or welded to the vertical members 103 of the frame.

In one form one or more of the panels may be arranged to be opened like a door. In the illustrated form as per FIG. 4, the panel 211 is attached to the frame 101, or vertical member 103 by a hinge connection such that the panel can be pivotally opened and closed. The panel may comprise a handle 211a as shown in FIG. 3 to allow a user to grasp the panel and open the panel. In another form the panel 211 may be arranged to be opened by sliding the panel. In this form the frame 101 may comprise a track on one or part of a longitudinal member. The panel may comprise a sliding arrangement such as a wheel that can slide in the track and allow the panel to be slidingly opened. In both panels 210, 211 may be arranged to be opened by a hinged connection or a sliding connection. The openable panel 211 allows a person servicing the tank to access the sewage digestion system or the collection tank. The collection tank is arranged to collect sewage and process it. The details of the sewage digestion system will be described later. The openable panel 211 allows the servicing person to easily access the sewage digestion system and collection tank, in order to empty the collection tank and service or clean the digestion system. The panel 211 also allows access to other internal components and parts of the sewage collection system 100. The openable panel 211 makes it easy to access various internal parts of the system 100 because the entire system does not need to be dismantled in order to access the internal components. This is advantageous because it makes servicing the system 100 and other internal components easy, quick and efficient.

The side walls 201a, 201b may, in other forms, comprise more than removable two panels. In further alternate forms the side walls may comprise one single removable panel. The side wall 201b also comprises panels similar to the side panels 210, 211. The panels attached to the side wall 201b are not shown in the figures.

The panels may also be made from a rigid and corrosion resistant material such as galvanized steel. In other forms other suitable materials such as aluminium may be used.

The base wall 202 may comprise one or more panels attached to the base frame 102. The panels on the base provide an enclosed base and stop or reduce sewage or other materials from seeping out of the toilet. The base panels (not shown) may be of a similar form as that of the panels 210, 211.

The roof 204 comprises a panel 212. The panel 212 is attached to the roof frame 104. The roof panel 212 encloses the sewage collection system. The roof panel 212 may be bolted onto the roof frame 104. In another form the roof panel may be riveted or welded onto the roof frame. The roof panel 212 may be made from galvanized steel or aluminium or any other rigid, corrosion resistant material. The roof panel 212 may be similar in structure to the side panels 210, 211.

The roof 204 comprises a moveable section 206. The section 206 can be moved such that the height of the roof can be adjusted. The roof section 206 comprises a suitable mechanism to allow the height of the roof section 206 to be adjusted. The roof section 206 may comprise a ratchet mechanism, or a pulley mechanism with a handle to move the roof. In another form the roof includes a locking mechanism that allows the roof to be locked at various locations or heights. In a further alternate form only a section of the roof may be adjustable.

FIGS. 2 to 4 show one embodiment of an adjustable roof 204. The roof 204 comprises a moveable section 206 that is a panel 206. The panel 206 is attached to a telescoping arrangement. The telescoping arrangement is formed or attached to the frame 101. The telescoping arrangement comprises elongate members that extend vertically downward from the panel 206 and are able to be moved in a vertical direction. The elongate members may be posts. The posts may be any suitable shape and have any suitable cross section. In the illustrated form the roof section 206 comprises four elongate members 207a, 207b, 207c, and 207d. The elongate members 207a-207d are posts and extend vertically downward from the panel 206. The elongate members 207a-207d interact with the frame 101, in particular the roof frame 104. The elongate members 207a-207d, or posts, extend into the roof frame 104. The roof frame 104 includes a plurality of elongate passages 208a, 208b, 208c, 208d that are arranged to receive the elongate members 207a-207d. The passages 208a-208d are complementary to the elongate members 207a-207d such that the elongate members can fit into and move within the passages to move the roof section. The elongate members 207a-207d include a locking mechanism to lock the elongate members 207a-207d within the passages 208. The locking mechanism may be a protrusion that engages with a complementary hole in the passages 208. The locking mechanism allows the elongate members 207a-207d to be locked in place at an appropriate height. The locking mechanism can includes a release mechanism that allows a user to release the elongate members 207a-207d from the locked position so that the height of the roof can be adjusted.

The adjustable height of the roof section 206 is advantageous because the roof can be lowered to permit transport through low height access tunnels. The section 206 of the roof can be adjusted and raised to the working height. The roof section 206 being raised of the roof frame 104 provides a space 209 between the roof section 206 and the roof frame 104, upon which the roof section 206 sits on when the roof is at its lowest position. The space 209 provides ventilation of the sewage collection system especially around the toilet.

The sewage collection system 100 comprises two separate areas, an operational area 220 and a collection area 221. The operational area 220 and collection area 221 are hollow spaces within the frame that are defined by the frame 101, the side walls 201a, 201b, the base wall 202 and the roof 204. The operational area 220 is separated from the collection area 221 by a partition 222. The partition 222 is in the form of a wall. The wall may be in the form of a panel such as the side wall panel 210 or 211. The partition 222 may be bolted, riveted or welded to the frame. The partition 222 is made from a rigid and corrosion resistant material such as galvanized steel or aluminium, but other rigid and corrosion resistant materials may also be used.

The partition divides the space defined by the walls, the base and the roof into two areas. The partition 222 may be any other suitable form such as a moveable partition comprising a bellows section. The partition may also be in the form of a sliding screen.

The operational area 220 includes an cubicle 230. The enclosure or cubicle 230 is shown in FIGS. 2 and 10 most clearly. The enclosure or cubicle 230 includes and is defined by a plurality of vertical walls 231a, 231b, 231c and a floor 232. The walls and floor of the enclosure define an operational area 220. The enclosure 230 may be formed as a single piece where the walls and floor are integral to each other. The floor 232 of the cubicle is sloped. The floor 232 slopes in any suitable direction. The corners of the cubicle are radiused. The edges 233a-233c that forms the junction of the floor 232 and walls 231a, 231b, 231c are rounded or radiused, as seen in FIG. 2. The edges may be any suitable radius. In one example the edges 233a-233c may be radiused at a radius between 100 mm to 1.5 m. The sloping floor and the radiused edges and corners provide for easier cleaning. The sloped floor directs any cleaning liquid or effluent outward from the cubicle. The sloped edges and rounded corners ensures no dirt or debris is caught in the corners or radiused edges.

The cubicle 230 is a shell of fire resistant and anti static fibre reinforced plastics material. This material is advantageous because it can be used in mines and meets the safety requirements and regulations associated with toilets used on mining operations.

The cubicle 230 further comprises a toilet pan 240. The toilet pan 240 is made from galvanized steel. The toilet 240 may be a standard toilet system that includes a flush system, a flush mechanism and a pan. The pan includes a seat to allow a user to sit on the seat and a hollow area to collect the sewage as a user urinates or passes stools.

The toilet pan 240 also includes an outlet pipe that connects to a sewage digestion system and collection tank. The toilet pan 240 is connected to a venturi device 941 (referred to as a venturi) within it and is flow matched to the outlet pipe and other pipe work that connects the toilet 240 to the sewage digestion system and collection tank. The venturi could be a pneumatically activated venturi vacuum generator device or a venturi tube. The venturi is positioned in the hollow of the toilet 240 and adjacent the outlet pipe. FIG. 14 shows the venturi 941 being connected to the toilet pan 240 via a section of pipe 943. The venturi 941 induces a vacuum within the outlet pipe section 943 to evacuate the contents of the toilet pan 240.

The sewage collection system 100 also includes a door 250. The door 250 is attached to the frame 101. The door 250 is attached by a hinge. The door 250 is pivotally attached and can open and close by pivoting along the frame. The door 250 is made from a rigid, corrosion resistant material such as galvanized steel or aluminium. In another form the door 250 may be made from a fire resistant and anti static fibre reinforced plastics material. The door 250 may be removably attached to the frame 101. The door 250 extends part of the height of the frame, as seen in FIG. 3 and FIG. 4. There is a space 251 left between the base frame 102 and the door 250. The space 251 is advantageous because it provides a space for ventilation and air to flow. The space 209 and space 251 at the top and bottom of the door allows for flow of air and promotes convection of air around the cubicle 230. The air can flow through the enclosure or cubicle 230 to reduce the smell and allow fresh air to flow into the cubicle 230 to make the toilet more fresh smelling and provide a user with a more pleasant experience.

The toilet pan and the cubicle 230 can be enclosed by closing the door 250. This provides privacy to the user of the toilet, unlike some prior art mine toilet systems in which the user is exposed while using the toilet pan 240. The cubicle 230 being closed is advantageous because the user can use the toilet in privacy making the present invention particularly useful for women to use.

The sewage collection system 100 further comprises a sewage processing or digestion system 600. The sewage processing or digestion system 600 is a system arranged to collect sewage from the toilet pan 240 after the toilet is flushed and digest the solid sewage to produce liquid effluent with low turbidity. The processing system comprises a biological agent or biological organism that is arranged to digest or break down the collected sewage. The sewage digestion system further includes aeration to introduce air into the digestion system to agitate and move the sewage. The added air may also accelerate digestion of the collected sewage. Liquid effluent is removed from the collected sewage. A small volume of the liquid effluent is sterilised and used as flush liquid in the toilet pan 240. The system is arranged to recycle the effluent within the system which is advantageous as there is no need for a water source for the flush cycle. This makes the sewage collection system particularly suitable for use in remote locations such as underground mines. Further the recycled effluent is advantageous because it allows for the provision of a flushing toilet in underground mines which is more hygienic and desirable than the collection tank type prior art toilets described earlier.

The extracted effluent is recirculated and used in the flushing cycle of the toilet. The liquid effluent is provided to the flush system of the toilet. The flush system includes a reservoir tank that is arranged to hold the liquid effluent and discharge liquid effluent into the toilet when the flush mechanism is activated. The flush mechanism will be described later.

FIGS. 5 and 6 show one embodiment of the sewage processing system 600. The sewage processing system 600 comprises a collection tank 601, as shown in FIG. 5. The collection tank 601 is positioned in the collection area 221 of the sewage collection system 100. The collection area 221 is the area adjacent the end wall 201c. The collection tank 601 is substantially large and occupies a majority of the collection area 221. In one example the collection tank 601 may have a capacity 500 L to 3000 L. The collection tank 601 is arranged to collect the sewage from the toilet 240 and hold the sewage. The collection tank 601 comprises a plurality of walls, a base and top section. In the illustrated form the tank includes four vertical walls, a base and a top section. The top section may be removable and may be in the form of lid. The collection tank 601 may also include sloped sections 602 in the base. The sloped section allows sewage to be localised into a single location. The base of the collection tank 601 also includes rounded corners so that sewage does not remain trapped in the corners of the base of the collection tank 601.

FIG. 11 shows an embodiment of the sewage processing system 600, with the collection tank 601 being positioned at the base of the sewage collection system 600.

In an embodiment the collection tank is aerated across its bottom surface. The sewage is broken up in the collection tank 601 and this is site where majority of the sewage digestion occurs.

The collection tank 601 comprises a biological agent or organism that is present in the collection tank. The biological agent is arranged to break down solid sewage collected within the collection tank 601. The bacteria are preferably aerobic bacteria. The bacteria are naturally occurring bacteria within the stools and sewage. The sewage digestion system 600 is arranged to promote the growth of aerobic bacteria and reduce the growth of anaerobic bacteria. The increase aerobic bacteria reduce the smell produced in the sewage digestion system 600.

The bacteria feed on the solid sewage and break down (i.e. digests) the solid sewage.

The housing also includes a spray mechanism associated with the housing. The spray mechanism is a time controlled spray. The spray mechanism is pneumatically controlled or mechanically controlled. The pneumatically or mechanically controlled spray mechanisms are safer than electrically controlled components. The spray mechanism adds nutrients to the collection tank 601. The nutrients promote the growth of the bacteria within the sewage processing system 600 and collection tank 601.

The bacteria and the conditions in the collection tank 601 allow the collection tank to function for at least one mine cycle requiring servicing or emptying. In particular the aeration of the collection tank 601 and the addition of nutrients into the collection tank to promote the growth of aerobic bacteria are advantageous as it allows the collection tank 601 and the sewage processing system 600 to function for an extended period of time such as a mine cycle. Generally mines operate in cycles and each cycle is approximately a year. At the end of each cycle the equipment within the mine is serviced or removed or replaced. The large collection tank 601 and the aerobic bacteria within it allow the system 600 and system 100 to function without requiring servicing or emptying for at least one mine cycle. This is advantageous since the sewage collection system 100 does not need to be serviced as regularly as some prior art toilets. Further the bacteria that digest the solid sewage and reduce the amount of solid sewage hence extending the time to empty the collection tank.

The bacteria can be any suitable bacteria that feed on solid sewage and faecal matter. This is advantageous since there is less requirements to constantly clean and service the sewage collection system 100 and collection tank 601. The presence of aerobic bacteria, rather anaerobic bacteria is further advantageous because the sewage collection system does not smell since the sewage is constantly being broken down. This ensures a more hygienic and more pleasant experience for the user of the sewage collection system 100.

The collection tank 601 further comprises an outlet pipe at the base of the collection tank 601. The outlet pipe can be used to empty the collection tank during servicing of the system 100. The pipe is arranged to be coupled to a hose or a pump to facilitate removal of collected sewage material in the tank 601. Servicing of the tank 601 is simple because a user simply needs to open the panel 211 to gain access to the collection tank 601.

The sewage digestion system 600 further comprises a plurality of treatment tanks. These additional treatment tanks are arranged to further process the sewage and black water collected and extract effluent that is recycled and used in the flush cycle of the toilet 240.

In the illustrated form, shown in FIG. 6, the sewage digestion system comprises four treatment tanks 700, 701, 702, 703. The digestion system 600 may however comprise any suitable number of additional treatment and processing tanks. Each of the treatment tanks 700-703 includes an inlet and an outlet within each tank. Each of the treatment tanks includes a plurality of walls, a base and a roof. The walls, the roof and the base of the treatment tanks define a hollow space within each of the treatment tanks 700-703. Each of the treatment tanks includes sloped sections in the base. FIG. 6 shows a sloped section 704 within the base of the first treatment tank 700. The sloped sections allow sludge, solid sewage or liquid sewage to be collected in a localised area within the tank. The tanks 700-703 can be any suitable shape and dimensions.

In one form the four treatment tanks 700-703 may be nested and held within the collection tank 601. FIG. 7 shows an illustration of the treatment tanks 700-703 being nested within the collection tank 601. Alternatively the treatment tanks 700-703 may be positioned above the collection tank 601, as shown in FIG. 11. The treatment tanks 700-703 are connected to each other via a pipe network which is not illustrated for clarity. In a further alternative the treatment tanks may be positioned adjacent the collection tank or below the collection tank.

The collection tank 601 is in fluid connection with any one or more of the treatment tanks 700-703. Further the treatment tanks 700-703 are arranged such that they are in fluid connection with each other. In one form the collection tank 601 is in fluid connection with at least the first treatment tank 700 via a pipe that connects the outlet of the collection tank 601 with the inlet of the tank 700. The treatment tanks 700-703 are in fluid communication with each other via a plurality of pipes. FIG. 7 shows the pipe connections between the various treatment tanks 700-703. FIG. 7 shows pipe 705a connecting the first treatment tank 700 to the second treatment tank 701, a pipe 705b connecting between the second treatment tank 701 and the third treatment tank 702 and a pipe 705c connecting between the third treatment tank 702 and the fourth treatment tank 703. The pipes may be made from any suitable material such as moulded plastics material.

The sewage collection system 100 comprises a pipe network that includes a plurality of pipes. For ease of understanding all the pipes and interconnections are not shown. The pipes allow sewage and liquids to flow between the various tanks 601, 700-703.

In use, liquid sewage is transferred from the collection tank 601 is passed to the first treatment tank 700. The water is moved between the tanks using the force of gravity and liquid pressure due to displacement of liquid. The sewage collection system 600 comprises a compressed air circuit that allows creation of vacuums and pressures to move liquid around the system. This will be explained further later in the specification. This is advantageous as there are no moving parts making the sewage collection system of the present invention suitable for use in underground mines. Further no moving parts means there is a reduced chance of clogging or jamming in the system.

Preferably the treatment tanks 700-703 also act to further digest the sewage material. Effluent is passed from the collection tank 601 to the first treatment tank 700. Effluent from near the volumetric centre of the collection tank 601 is provided into the first treatment tank 700.

The first treatment tank 700 is lightly aerated from a point above the settlement layer. Effluent from a point just above the settlement layer is led into the second treatment tank 701 and then from the second tank 701 into the third treatment tank 702 where the effluent is lightly aerated. The first, second and third treatment tanks are identical to each other. Effluent from the third treatment tank 702 is led into the fourth treatment tank which has no aeration.

Preferably the effluent flows through the tanks in the sewage processing system under gravity. The volume of effluent being delivered into the collection tank 601 from the flush cycle displaces an equal volume from the collection tank into the first treatment tank 700, which in turn displaces volume from the first treatment tank 700 into the second treatment tank 701 and so on through the system to the fourth treatment tank 703 which displaces a volume of water that becomes the source of the flush water. The effluent from the fourth treatment tank 703 is sterilised which will be described later.

The fourth treatment tank 703 includes a pipe that connects the fourth treatment tank 703 to the toilet 240, in particular the reservoir tank of the flush system associated with the toilet 240. The effluent is recycled and used in the flush cycle for the toilet 240.

The treatment tanks 700-703 each may also comprise a biological agent or organism to facilitate break down of any solid sewage or faecal matter that may be introduced into the treatment tanks 700-703. Preferably the biological agent may be introduced during installation of the treatment tanks. The successive treatment tanks 700-703 digest more of the solid effluent and settle the residual solids. This process of digestion and settling the residual solids produce an effluent with progressively lower turbidity. The fourth treatment tank 703 comprises effluent with the lowest turbidity in the sewage treatment system 600. Lowering the turbidity and suspended solids in the effluent stream is critical as it assists in ultraviolet sterilisation of the effluent (i.e. effluent). It should be noted the treatment tanks act mainly as settlement tanks where effluent or sewage is digested and solids are settled out of the effluent to produce flow with low turbidity.

FIG. 12 shows a detailed view of the reservoir 710 that comprises a weir 711 within it. The reservoir is part of the sewage treatment system and is preferably positioned vertically above the fourth treatment tank 703. Alternatively the reservoir may be positioned adjacent the fourth treatment tank 703. The height of the weir in this reservoir gives a constant head, with overflow water falling back into the treatment tank 703. The constant head is used to ensure that the effluent draining from a fitting 712 at the base of the reservoir is at a constant pressure and when flowing through a pipe with a fixed cross section and effective length, produces a constant flow.

In one example the constant flow is 3 L/min and this flow of effluent is directed into at least one but preferably a plurality of ultra-violet (UV) sterilizing unit 1100 (described later). The UV sterilizing unit sterilises the effluent to kill pathogens and other microbes within the effluent. The sterilised effluent is recycled and used as flush liquid in the toilet pan 240. The flush volume is a small volume ideally 1 liter or less, to ensure there is reduced splash back.

The reduced flush volume is also advantageous because the reduced volume of sterilised effluent does not pose a risk to the bacteria within the sewage processing system 600 (i.e. the collection tanks 601 and treatment tanks 700-703). If a large amount of sterilised effluent is introduced into the sewage processing system 600, the aerobic bacteria is killed. Therefore the reduced flush volume reduces the chances of killing the bacteria within the sewage processing system 600 when the flush liquid and sewage is introduced into the collection tank 601 after flushing the toilet pan 240.

In one embodiment the collection tank 601 includes one or more growth structures 800 that serve as a surface for the bacteria to attach to and reproduce. FIG. 8 shows a view of these growth structures 800. The growth structures may be any suitable shape. In one form these structures 800 are spherical in shape, as seen in FIG. 8. The growth structures 800 are arranged to provide an increased surface area for the introduced biological organism to “cling to” and begin reproducing. The bacteria clings to the growth structures and begins reproducing. The growth structures 800 provide an increased surface area for the bacteria to colonise.

The growth structures are generally present in the collection tank 601. The growth structures may also be present in any one or more of the treatment tanks 700-703. The growth structures are introduced into the collection tank 601, and/or any one more of the treatment tanks 700-703 during manufacture. The growth structures 800 are porous to allow sewage to flow through them. The liquid that flows through the structures 800 is treated in each of the treatment tanks 700-703 to produce effluent that can be recycled into the flush system for the toilet 240.

The sewage collection system 100 comprises a sterilization system 1100, as shown in FIG. 11. The sterilization system 1100 comprises at least one but preferably a pair of UV sterilization tubes 1101, 1102. In other embodiments the sterilization system 1100 may comprise a plurality of UV sterilization tubes.

FIG. 11 shows an embodiment of the sterilization system 1100. FIG. 11 shows the sewage collection system 100 with additional features not shown in FIGS. 1 to 10 for clarity purposes. The sewage collection system 100 shown in FIG. 11 is similar to that described earlier and includes all the features described earlier. The UV sterilizing tubes may be positioned above or adjacent the treatment tanks 700-703. The UV tubes 1101, 1102 are in fluid communication with the reservoir 710. The controlled low flow rate in combination with the radiant output of the tubes 1101, 1102 ensures that all effluent being used in the flush cycle of the toilet pan 240 is subject to many times the accepted radiation dosage required to eliminate E. coli and other pathogens.

Once the effluent is sterilised it is transported to and stored in the cistern 1110 (as shown in FIG. 11). The cistern is in fluid communication with the toilet pan 240 and collects liquid that is used in the flush cycle of the toilet pan 240.

The toilet 240 includes a flush system 1109 that comprises flush mechanism to flush the toilet and wash away sewage material after someone has used the toilet to urinate or pass stool. The flush system comprises a cistern and a flush cylinder. The toilet pan is also connected to and in fluid communication with a cistern 1110. The cistern is preferably positioned above the toilet pan 240. The cistern 1110 is connected to and in fluid connection with a flush cylinder 1111. The flush cylinder is part of the flush mechanism. The sterilized effluent is gravity fed into the flush cylinder 1111 in preparation for the flush cycle and activation of the flush by the user. The cistern 1110 comprises a float switch 1112 that controls an airlift pump 1113 to replenish the cistern when the level drops below a predetermined level. The float switch 1112 may be float valve or a ball valve or other suitable switch that is preferably pneumatically or mechanically operated. The airlift pump 1113 lifts water from the fourth treatment tank 703 into the reservoir 710. The airlift pump is employed to minimize the number of points where clogging can occur. The airlift pump 1113 is activated by the float switch 1112 in the cistern 1110.

The flush mechanism may be manually operated or automatically operated based on a timer. When the flush is activated, a pneumatic circuit is opened. Compressed air flows through the pneumatic circuit to open a valve between the toilet outlet and the collection tank. The venturi positioned adjacent the toilet outlet activates and creates a vacuum causing contents of the toilet 240 to be sucked out of the toilet and flow into the collection tank 601. The vacuum is only present in between the toilet pan 240 and venturi device 941. The air stream from the venturi 941 creates a vacuum in the outlet pipe section 943 and also creates a force to push the sewage into the collection tank 601. The venturi 941 and the presence of the vacuum and force pushing the sewage into the collection tank 601 removes the need to position the toilet pan 240 above the collection tank 601.

The pneumatic circuit may be further arranged to activate the spraying device to spray bacteria into the collection tank once the toilet is flushed. For clarity purposes the pneumatic circuit is not shown in the drawings.

The pneumatic circuit also includes one or more air distribution units. In one form each of the treatment tanks 700-703 includes at least one air distribution unit within it. The air distribution unit is an elongate shape. For example the air distribution unit is a hose with a plurality of holes in the hose, or the air distribution unit is a rigid rectangular housing with a plurality of outlet holes in the rectangular housing. The air distribution has an inlet that is arranged to receive a compressed air transmission line. The compressed air transmission line delivers air to the air distribution unit. The air distribution unit may also be arranged to include various other parts such as an inlet valve, an outlet valve, a pressurised reservoir of air, flow regulators and one or more gauges. The compressed air exits from the outlet holes into each treatment tank. The air distribution unit causes agitation of the contents of the treatment tank due to the compressed air being pumped into the treatment tank. The agitation and moving of the material assists in breaking down the waste material that may be in the treatment tanks 700-703. Further the agitation is advantageous because the waste material does not get collected in the corners or in one particular area of the treatment tank 700-703.

The collection tank 601 also includes one or more aeration units positioned within the collection tank 601. The air distribution units may be positioned at the base of the collection tank 601. The aeration unit may be an elongate shape with outlet apertures. For example the aeration unit may include a hose with outlet apertures or a rigid rectangular housing with outlet apertures. The aeration unit positioned within the collection tank 601 also includes an inlet that connects to air transmission line and is arranged to receive pressurised air. The air moves out of the aeration unit via the outlet apertures. In one form the aeration unit is a hollow unit that can house other parts such as valves, a regulator, a gauge and even a compressor. In alternate forms the aeration unit used in the collection tank 601 may be similar in structure to the air distribution used on one or more of the treatment tanks 700-703. The aeration unit is advantageous because it provides convection air currents through the waste material. The air introduced through the aeration unit into the collection tank 601 causes agitation or stirring of the waste material such that the waste material does not remain stagnant in one single location. The agitation or stirring also stops the waste being collected in the corners of the collection tank 601.

The agitation aids in maximising the contact between the bacteria in the collection tank 601 and the waste in the collection tank. The agitation caused by the pressurised air delivery also results in quicker digestion of the waste and faecal matter.

The sewage collection system 100 as per FIG. 11 includes an additional bund 1400. The bund is a further enclosure that is positioned about at least the collection tank 1400 to prevent leakage of fluids from out of the collection area 221. The bund 1400 comprises at least two longitudinal walls 1401 and one transverse wall 1402. The bund 1400 also encloses the operational area and a portion of the cubicle. The bund does not have a front wall so that access to the cubicle 230 is not restricted. The bund is advantageous because it traps any leaked effluent and prevents escape of sewage or effluent into the mine. As shown in FIG. 11 the bund further comprises an opening that connects to an outlet pipe in the collection tank 601 to allow emptying of the collection tank 601. The bund 1400 was not illustrated previously for clarity purposes.

The sewage collection system 100 includes a pneumatic operation circuit that powers and operates the various parts of the sewage collection system 100. The pneumatic circuit 900 comprises a plurality of transmission lines, valves, and controllers. Air is supplied from an external air supply. The pneumatic circuit further comprises a manifold for dividing the pressurised air into the various transmissions lines. The pneumatic circuit includes one or more air pressure gauges to measure and indicate the air pressure in the system. The pneumatic circuit further comprises controllers that may be in the form of air pressure regulators. The controllers control the amount of airflow supplied.

FIG. 9 shows a schematic diagram of one embodiment of a pneumatic circuit 900 that can be used as part of the sewage collection system 100. The compressed air is supplied externally from an external supply in a mine or other remote location.

The supply section 901 includes an inlet valve 902 that receives air supply from an external air supply. The inlet section may comprise an air processing unit 903 that is arranged to process the incoming air, for example reduce the flow speed, filter the incoming air or reduce the air pressure.

The incoming air is supplied to an aeration section 910. The aeration section is the part of the circuit that is positioned within or adjacent the collection tank 601 and provides compressed air into the collection tank 601 to facilitate agitation of the sewage and increase the rate of digestion (i.e. breakdown) of the sewage material. The aeration section 910 comprises an aeration unit 911. The aeration 911 includes at least an outlet valve 912, the outlet valve being a needle valve in one example. However other outlet valve types can be used. The aeration unit 911 may comprise a vent adjusted regulator 913 to regulate the flow or pressure of the air supplied. The outlet apertures and the housing of the aeration unit 911 are not shown in the schematic diagram. The outlet valve 912 provides air to the outlet apertures in the aeration unit 911 and to the collection tank 601.

The pneumatic circuit 900 further includes three air distribution units 920, 921, 922. Each air distribution unit can be positioned within each of the treatment tank's 700-703. In the illustrated form only the first three treatment tanks 700, 701 and 702 comprise an air distribution unit. The air distribution units 920-922 are identical to each other in construction. As per FIG. 9, in one form the air distribution units 920-922 comprise an outlet valve, an inlet valve and an accumulator tank or reservoir of compressed air. The outlet valve is flow controlled valve that is controlled to maintain a set amount of flow or pressure. The parts of the air distribution unit will be described with reference to one air distribution unit 920, since the others are identical. The air distribution unit 920 comprises an inlet valve 925 with a pneumatic actuator 926 that is controlled. The inlet valve 925 can be any suitable valve; in one example the inlet valve is 3 port/2 position valve. Other valves such as a 4 port/2 position or 2 port/2 position valve can also be used. The air distribution unit further includes an accumulator 927. The accumulator serves to store pressurised air within it until the outlet valve 928 is opened. The outlet valve 928 may be any suitable valve, in one example the outlet valve 928 is a flow controlled valve. It should be understood that various flow or pressure regulators or controllers or actuators may also be added to the air distribution units 920-922 in order to change the response characteristics of the air distribution unit or any of its components.

As described the toilet 240 includes a flush system. The flush system 1109 is housed behind the end wall 231b of the enclosure 230. The flush system includes a reservoir tank and a float operated ball valve 930 to refill the reservoir tank. The reservoir tank referred to here can be the cistern 1110 or flush cylinder 1111. The reservoir tank receives treated effluent from the fourth treatment tank 703. The treated effluent received by the reservoir is the recycled effluent extracted from the sewage collected system 600 (more specifically from the fourth treatment tank 703) after processing and sterilising the effluent using UV sterilisers as described earlier.

In an embodiment the system 100 may comprise a ball valve 930. The ball valve 930 is a pneumatically activated ball valve. The pneumatic circuit includes a flush refill section 931. The flush refill section comprises the ball valve 930, an inlet valve 932 that controls the air flow to the ball valve 930. The inlet valve controls when air pressure is supplied to the ball valve 930 to open the ball valve 930 and allow the flush to refill. The valve 932 may automatically controlled by a programmed controller or based on a pre-set timing sequence, the controller being a pneumatic controller. Preferably the ball valve 930 is the same as the float switch 1112. The float switch 1112 may be in the form of the ball valve 930 or the ball valve 930 may form part of the float switch. 1112. In one form the ball valve may also activate the air lift pump 1113 to refill the cistern. In one form the refill section 931 is arranged to refill the cistern 1110 as described earlier.

The inlet valve 932 may be any suitable directional control valve, in this example a 5 port/2 position directional control valve. The inlet valve may be solenoid controlled or air piloted or any other suitable form. All other inlet valves described may be any suitably actuated valve such as air piloted.

The pneumatic circuit comprises a flush vacuum section 940. The flush vacuum includes a venturi 941. The venturi 941 is pneumatically operated. The flush vacuum section comprises a valve 942. The valve 942 may be any suitable directional control valve, in this example a 5 port/2 position directional control valve. The inlet valve may be air piloted or any other suitable form.

The valve 942 introduces air into the venturi 941 that causes a vacuum within the outlet pipe section from the toilet pan 240 and causes a pushing force between the venturi 941 and collection tank 601 to push sewage into the collection tank 601. This is advantageous as the introduced air causes both a vacuum and a pushing force without the need for pumps. Sewage is transported with minimal moving parts reducing the chances of clogging.

The sewage collection system 100 further comprises a deodorising spray 950 that is arranged to spray deodorant into either the collection tank 601 or the enclosure 230 or both. The deodorising spray assists to provide a fragrant smell and provide the user with a pleasant experience when using the sewage collection system 100, in particular when using the toilet 240. The deodorising spray mechanism 950 is a pneumatically controlled spray mechanism and will be described later.

The pneumatic circuit also comprises spray mechanism 960 that is arranged to spray an enzyme into the collection tank 601 and in some embodiments into the treatment tanks 700-703 also. The enzyme promotes the growth of bacteria that assists in digestion of solid sewage. The spray is activated by the pneumatic valve 961 which is preferably an air piloted valve.

The pneumatic circuit also demonstrates the position of the light activation mechanism.

The sewage collection system 100 comprises a flush system that includes a flush mechanism. The flush mechanism is a push button type mechanism. The flush mechanism controls the flush pump 1111 to eject water from the flush pump 1111 by introducing high pressure air, thus creating space for water from the cistern 1110 (or reservoir tank for the flush) to refill the flush cylinder 1111.

FIG. 10 shows a flush button 970 that is arranged to be pushed by a user after the user has used the toilet 240 to either pass urine or stools or both. The flush button 970 operates a pneumatic timer 1300 which runs until the flush cycle is complete.

FIG. 13 shows a schematic of one embodiment of the sewage collection system 100. FIG. 13 shows the pneumatic timer. In one embodiment the pneumatic timer 1300 consists of a pneumatic cylinder driving a cam at a constant and repeatable speed past a series of pneumatic valves. The rate at which the cylinder operates is fixed by adjusting the flow control on the outlet side of the cylinder. The flush cycle is divided into three phases wherein each phase is timed. The first phase the venturi 941 is activated which provides both the vacuum to evacuate the contents of the toilet pan and also the airstream to transport the sewage from the pan to the sewage processing system 600 and more specifically transport the contents of the pan to the collection tank 601.

In the second phase the flush is activated. At this point high air pressure is directed into the flush cylinder 1111 where a small quantity of sterile effluent is forced out through a pneumatically opened valve and is injected into the toilet pan 240 (i.e. into the flush ring of the toilet pan 240). High pressure air is introduced into the flush cylinder to force out the effluent. Air is entrapped in the pressurised effluent as it is injected. The flush cylinder 1111 acts to pressurise the effluent within it. The injected air improves the washing action of the effluent. The high air pressure to the flush cylinder 1111 is stopped hence allowing the sterile effluent from the cistern 1110 to flow into the flush cylinder through a flap valve. Air within the flush cylinder 1111 is vented to atmosphere simultaneously or prior to introducing sterile effluent from the cistern 1110.

At the same time that the flush water flow from the flush cylinder 1111 is terminated another valve actives an atomized deodorant spray into the sterile cistern in preparation for the next flush. Further as the flush cylinder 1111 is terminated a further valve is activated to activate the deodorising spray 950 that sprays a deodorant into the enclosure or cubicle 230. The deodorising sprays are advantageous as they present a pleasant smell and suppress foul smells of sewage or effluent. This is advantageous as it makes the use of the toilet a more enjoyable experience.

Simultaneously a preparation designed to promote the growth of bacteria is injected into the collection tank 601. In alternate embodiment this preparation may be injected into at least one or more of the treatment tanks also. The preparation is injected using compressed air.

The preparation may be introduced via a compressed air spray mechanism 960. In one embodiment the preparation may comprise an enzyme that may promote the growth of bacteria. Alternatively the enzyme spray may be arranged to spray bacteria into the collection tank or into the treatment tanks 700-703. The enzyme spray is a pneumatically operated spray mechanism. The enzyme spray 960 activation is controlled by an inlet valve 961. The inlet valve 961 may be any suitable directional control valve, in this example a 5 port/2 position directional control valve. The sprays are activated for a predetermined length of time that is controlled by the length of activation cam within the pneumatic timer.

The venturi 941 remains activated throughout and for some time after the flush cycle is terminated. The venturi as described creates a vacuum to evacuate the contents of the toilet pan 240. The venturi 941 being activated for an extended period of time is advantageous as it ensures all the contents of the pan are evacuated. This reduces the chances of any pathogens remaining in the toilet pan and reduces the chances of infection.

A very small volume of sterilised effluent is used in the flushing of the pan under high pressure. This is advantageous because the small flush volume reduces the risk of contamination from contact with the water. The small volume of flush water is also advantageous because it reduces the chances of killing the bacteria or microbes in the collection tank 601 and the treatment tanks 700-703. A large amount of treated sterile effluent being introduced into the collection tank 601 will kill the bacteria i.e. aerobic bacteria within the collection tank 601 hence the small flush volume reduces the chances of this and ensures the sewage in the collection tank is digested and the volume of bacteria is maintained within the collection tank 601.

The positions of the various components in FIG. 13 are only illustrative.

The sewage collection system comprises a light 1000 and a light activation system 980. The light activation system includes a valve 981 which will be described later.

FIG. 10 shows a view of the light that is positioned above the toilet. The light is activated by using the light activation system. The light is arranged to provide a non glare, reflected light. The light is fixed in a housing that is mounted to either the frame 101, or to a vertical member 103 of the frame or to part of the cubicle 230. The light 1000 is advantageous because it allows a user to see the toilet in the dark or low light areas, which can occur in underground mines or during night shifts. The light being air actuated is advantageous because it is safe to use in mines and other locations without the chances of an electrical fire or explosion.

The light 1000 is activated by an activation member 1001. In the illustrated form the activation member 1001 is a hook. The hook 1001 is arranged for a user to hang a helmet or other utility equipment. The hook 1001 is connected to a load sensing circuit. The hook 1001 is attached to an appropriate load sensing sensor. The load sensing sensor may be any suitable sensor for example a hydraulic sensor, a piezoelectric sensor, a mechanical sensor or the like. The load sensor is connected to a suitable interface circuit that is arranged to determine the load. The sewage collection system 100 comprises an external compressed air supply as shown in FIG. 13. The electrical energy required to operate the UV sterilisers 1101, 1102 and the cubicle light 1000 is generated by a generation means 1310. The generation means comprises alternator 1311 being connected to an air powered motor 1312. The generation means 1310 operates only when required. The generation means is triggered by the activation member 1001, more specifically by the user hanging their tool belt or helmet on the activation member 1001. The interface circuit is connected to the generation means 1310 and arranged to activate the generation means. The sensor and circuit is arranged to activate the air turbine and hence the light 1000 when a helmet, hard hat or utility belt is hung on the hook. The load sensing circuit is arranged to activate a valve 981 that is part of the light activation system 980. The valve 981 opens supply of compressed air from the air supply 901 to the air powered motor 1312 to activate the alternator to generate electricity to provide illumination of the light 1000.

The generation means 1310 and hence the light and UV sterilisers 1100 remain activated until the users belt remains on the activation member 1001 (i.e. the hook). An additional circuit ensures that the generation means also continues to run until enough effluent has been sterilised to refill the cistern partially emptied by the flush. In one embodiment the float valve may also be connected to a circuit that controls the activation of the generation means 1310. The light in the cubicle 230 remains active throughout the use of the toilet which is advantageous because it makes using the toilet safer for the user.

FIG. 13 shows a pressurised component box 1320 that houses the UV sterilisers 1101, 1102. The pressurised component box 1320 is arranged to house potentially electrically unstable components that could be considered an explosion risk, e.g. the UV sterilisers. The component box 1320 is approved to mining regulatory authorities. In one embodiment pressurised component 1320 is pressurised by compressed air prior to activating the generation means 1310. The component box 1320 is sealed and can only vent compressed air out of the enclosure. This ensures methane from the mine does not enter the component box making it safe for underground mines as it is explosion proof. In an alternate embodiment the component box 1320 is hermetically sealed to ensure the component box is explosion proof. In a further alternative embodiment the component box 1320 is sealed from external methane by introducing sand or any other inert fire proof material into the enclosure such that the inert fire proof material comprises the volume within the component box 1320 to ensure no methane can enter.

FIG. 13 shows the electronic components, in particular, the generation means 1310 as being positioned adjacent the component box 1320. This is one arrangement in which each part of the generation means (i.e. the air motor and the alternator) are positioned in their own separate pressurised box similar to pressurised component box 1320. However it is preferable to position the generation means 1320 and the components of the generation means in the component box 1320 to reduce the risk of explosions due to methane exposure. Preferably all electrical components are positioned within the pressurised component box to ensure safety of the system 100 and safety of the mine.

The component box 1320 comprises a pressure sensing valve 1321 that is positioned within the box 1320. The pressure sensing valve can be any suitable pressure sensing valve. Preferably the valve 1321 is a valve that is approved for use in underground mines. The pressure sensing valve 1321 determines the pressure within the box and controls a further valve that regulates the pressure within the box by either allowing the flow of compressed air into the box 1320 or venting the pressurised air within the box 1320. In an alternate embodiment the pressure sensing valve 1321 may regulate the pressure within the box 1320 by letting in compressed air or venting air within the box 1320.

In one embodiment the component box 1320 is always pressurised to ensure no methane enters the box 1320.

In one embodiment the pressure sensing valve 1321 is controlled by pneumatic timer 1300. The pneumatic timer 1300 causes the pressure sensing valve 1321 to pressurise the box 1320 before the UV sterilisers and generation means 1310 are activated. Once these components are deactivated (due to the pneumatic timer 1300), the pressure sensing valve 1321 is controlled to vent the air within the pressurised box 1320. This is advantageous because the electrical components are only operated in a pressurised environment, wherein the pressurised environment is generated by compressed air which is not an explosion risk. The pressurisation of the box 1320 causes any trapped methane to be evacuated from the box 1320.

The present invention has several other advantages. The present sewage collection system increases the hygiene levels for users. In particular the toilet pan is located separately from the collected sewage and sewage. The toilet pan is isolated within the cubicle 230 from the collection tank 601. This means there is no “splash back” of untreated sewage. Further the water from the flush is scavenged out by the vacuum from the venturi to leave the bowl dry and minimise the possibility of splashing of sewage from the toilet pan 240. The flush button 970 is mounted high, so that it cannot be operated while in a seated position. This ensures the user must stand to push the flush button 970 hence again reducing the chances of contamination via splash back.

The sewage collection system is pleasant to use because of the deodorising spray which is added to the flush and/or to the cubicle. Further the pan 240 is separated from the collection tank which reduces the exposure to raw sewage and reduces the smell within the toilet cubicle 230. The sewage processing system 600 utilises aerobic bacteria to digest the sewage rather than anaerobic bacteria which reduces offensive smells.

The sewage collection system 100 is also advantageous as it is safer to use. The toilet pan 240 is located near ground level hence the user simply steps into the cubicle 230 and uses the toilet pan 240. There is reduced movement required by the user. The increased safety is also contributed by the presence of the light 1000 which is activated by the user. A light in the mine environment makes the use of the sewage collection system safer.

As seen in FIG. 10, a toilet paper holder 1002 is positioned within the cubicle 230. The toilet paper holder 1002 is arranged to hold toilet paper for a user. The toilet paper holder 1002 can be opened to refill it with toilet paper. In an alternate form the toilet paper holder 1002 may also comprise the deodoriser spray 950. The deodoriser spray 950 may be positioned in the toilet paper holder 1002 to conceal it from the user. In the sewage collection system 100 the toilet pan 240 is at substantially ground level. In the preferred form the cubicle comprises a small step which is less than or equal to 100 mm. This is advantageous over at least some prior art toilets that include several steps to climb onto the top of a collection tank and use the toilet pan. The toilet pan 240 being substantially at ground level makes use of the toilet pan 240 safer. Further the presence of the light 1000 adds further safety because the user can see the cubicle and does not need to only rely on the helmet light.

A control panel (not shown) can be mounted on the panel 211. The control panel is preferably mounted on the inside surface of the openable panel 211. The control panel is a control panel that allows a technician to change various operating parameters of the various components of the pneumatic circuit. The control panel may also include functionality to allow technician to change or modify parameters related to any electronic components in the system for example the load sensing circuit. The user may be able to modify the length the light stays on, or the activation load of the load sensing circuit.

It should be noted that any electrical components referred to in the specification are safe for use in underground coal mines. This is advantageous because these components and hence the sewage collection system 100 can be used in underground mines and other confined spaces in a safe manner.

The sewage collection system 100 described above can also be modified to be used above ground in various remote locations such as open cast mines, construction sites and as “rest stops” on remote roads. The sewage collection system 100 can be modified to be solar powered rather than pneumatically powered. In the solar powered version some or all of the pneumatic components can be replaced with electrical components. The sewage collection system 100 will also comprise one or more solar panels that are arranged to capture sunlight. The sewage collection system will also comprise appropriate circuitry to convert the solar energy to electrical energy that can be used to power various parts of the system 100, described earlier.

Some alternate embodiments or additions will now be described.

In an alternate embodiment or the treatment tanks 700-703 may also comprise a spray mechanism within or adjacent the treatment tanks. The spray mechanism is arranged to introduce bacteria into the treatment tanks 700-703. Each tank may have a separate spray mechanism associated with it. The spray mechanism may be electronically controlled by a suitable controller and may introduce bacteria at regular time intervals or may introduce bacteria based on the volume of liquid within any of the treatment tanks. Each treatment tank 700-703 may also comprise a volume sensor to determine the amount of liquid or sewage within each treatment tank. The signals from the volume sensors can be used to control the spray mechanism to introduce the bacteria into any one or more of the treatment tanks 700-703.

In an alternate embodiment each of the treatment tanks 700-703 may also comprise a heat treatment device positioned within the treatment tanks. The heat treatment device may be an infrared lamp or heating coils positioned within the treatment tanks 700-703. The treatment tanks can also comprise radiation treatment devices, such as UV lights that are positioned within the treatment tanks 700-703. The heat treatment devices and radiation treatment devices are used to treat the liquids in the treatment tanks. The liquid (i.e. black water) is treated in every tank and passed from tank to the other.

In an alternate embodiment a suitable pump is also provided to allow liquid and sewage to be transported from the collection tank 601 to the treatment tanks. The same pump may also provide the required force to transfer liquid between the various treatment tanks. In another form one or more additional pumps may be supplied to provide the force to pump liquid from one treatment tank to the next. The pumps used may be pneumatic pumps. In other forms other suitable devices can be used to transmit sewage from the collection tank 601 to the treatment tank 700 and then to transmit liquid and/or sewage material between the treatment tanks.

In an alternate embodiment the light 1000 is air turbine powered. The air turbine is pneumatically powered.

In a further alternate embodiment the flush cycle or flushing of the toilet 240, the activation of the enzyme spray 960 and the activation of the deodorising spray 950 may be automatically activated. The activation of each of the flush cycle, the bacterial spray and deodorising spray may be individually programmable into a micro-controller. The micro-controller may be manifold with programmable outlet valves that are arranged to provide pneumatic activation to either one of the flush in the flush system, the deodorising spray or the bacteria spray. In another form the micro controller may be arranged to supply an electronic activation signal to activate either one of the flush in the flush system, the deodorising spray or bacterial spray. The micro-controller can be programmed to activate the flush, the deodorising spray and bacterial spray at various different times to one another.

In a further alternate embodiment the black water can be processed or cleaned using any suitable biological agent in combination with a chemical agent or radiation in order to extract liquid effluent. The liquid effluent may be treated using either one or a combination of a chemical agent or radiation to generate a sterile volume of liquid that can be recycled in the system and used as the flush liquid.

In an alternate embodiment the spray mechanism may be controlled to add more bacteria as the quantity of sewage in the collection tank 601 increases. The collection tank may also include a suitable volume sensor such as an optical sensor to measure the amount of sewage in the collection tank 601. The collection tank 601 may also comprise an alarm to send out a warning signal or sound when the collection tank 601 quantity limit is approaching.

In a further alternative embodiment the collection tank 601 may comprise a radiation device to further facilitate quicker break down of the solid sewage in the collection tank 601. The radiation device may be a UV light or a plurality of UV lights. The UV lights help to break down the solid sewage at a faster rate.

An alternate embodiment of the pneumatic circuit 1500 can be used will be described with respect to FIG. 15. The pneumatic circuit 1500 can be used instead of the circuit 900 described earlier. The circuit 1500 is preferable since it is more condensed and comprises fewer parts than the circuit 900. Like numerals in circuit 1500 refer to like parts referred to in circuit 900. The pneumatic circuit 1500 comprises a flush button 970. The flush button is a valve that is connected a valve 942. The valve activates venturi 941 and introduces compressed air into the venturi 941. The activation of the flush button also activates the timer cylinder 1501 which is connected to the timer control valve 1501a. The timer control valve 1501a controls air to the timer pilot network 1502.

The timer pilot network 1502 comprises at least one but preferably a plurality of timing valves. FIG. 15 shows the timing valves 1502a, 1502b, 1502c and 1502d. Each timing valve may control a different component of the circuit. The valves may be air piloted valves. Air from the flush cylinder 1111 is vented to atmosphere.

As the flush water flow is terminated a valve is activated to operate the deodorant injector 1503 and enzyme injector. The deodorant and enzyme is activated by a suitable valve. In this embodiment the deodorant and enzyme injector are one device. In this embodiment the deodorant and enzyme may be injected into the toilet pan 240 to reduce the smell and so that the enzyme is carried into the collection tank.

The circuit 1500 comprises the light switch 1504 which is the hook 1001 described earlier. Activation of the hook causes activation of the generation means 1310 (i.e. activation of the air motor that turns the alternator 1311) to generate electricity for the light 1000 and the UV sterilisers 1101, 1102.

The circuit 1500 illustrates the float switch 1112. The float switch is connected to or includes at least one air piloted valve. The float switch 1112 controls the air lift pump 1113. The air lift pump 1113 functions as described earlier. The circuit 1500 shows a flush pump 1111 (i.e. flush cylinder 1111) that may be controlled by the float switch 1112. Compressed air is introduced into the flush cylinder 1111 to push out sterilised effluent from the flush cylinder 1111 to form the flush liquid.

The circuit 1500 is more preferable to use since it is more condensed and requires fewer parts. This makes it easier to install and maintain. Further it is more suitable for use in smaller spaces. The circuit 1500 includes fewer parts and fewer moving parts resulting in reduced chances of breaking down or clogging.

It should also be understood that a pneumatic circuit that is a combination of the circuits 900 and 1500 can be used in the sewage collection system 100. The sewage collection system 100 is powered by compressed air which makes it suitable for use in underground mines since there is no use of electrical components. Further using compressed air provides fewer instances for clogging as compared to using conventional sewage pumps with rotating impellers. The sewage collection system 100 is particularly adapted for use in underground mines such as coal mines and is safe for use in such mines. The sewage collection system 100 provides a flushing toilet that is safer, more hygienic, provides privacy and is more pleasant to use in an underground mine.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It is to be understood that, if any prior art information is referred to herein, such reference does not constitute an admission that the information forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of stated features but not to preclude the presence or addition of further features in various embodiments of the invention.

1-34. (canceled)

35. A sewage collection system comprising a sewage processing system arranged to receive sewage and digest at least solid sewage from the received sewage, the sewage processing system arranged to extract liquid effluent with minimal turbidity.

36. A sewage collection system in accordance with claim 35, wherein the sewage processing system comprises a collection tank arranged to receive sewage, the collection tank comprising at least one aeration unit arrange to aerate the sewage collected within the collection tank to agitate the sewage and facilitate digestion of the solid sewage.

37. A sewage collection system in accordance with claim 35, wherein sewage collection system comprises one or more aeration units arranged to introduce air into the collection tank and the collected sewage in order to agitate the sewage and facilitate faster digestion.

38. A sewage collection system in accordance with claim 35, wherein the sewage processing system comprises a plurality of treatment tanks, each treatment tank in fluid communication with each other and one treatment tank in fluid communication with the collection tank.

39. A sewage collection system in accordance with claim 38, wherein any one or more of the collection tank or treatment tanks comprises a sloping bottom, the sloping bottom being arranged to localize sewage or sludge.

40. A portable sewage collection system comprising a plurality of walls defining a cubicle, a toilet pan disposed within the cubicle, the toilet pan being arranged to be flushed by a user to evacuate the sewage from the toilet pan, the system further comprising a sewage processing system that receives the evacuated sewage, the sewage processing system being arranged to extract liquid effluent, at least a portion of the liquid effluent being recycled and used to flush the toilet pan.

41. A portable sewage collection system in accordance with claim 40 wherein the sewage processing system comprises aerobic bacteria that assists to break down solid sewage and extract liquid sewage.

42. A portable sewage collection system in accordance with claim 40 comprising a sterilising unit arranged to sterilise a portion of the liquid effluent prior to using the effluent to flush the toilet pan.

43. A portable sewage collection system in accordance with claim 42 wherein the sterilising unit comprises at least one UV tube that receives a portion of the liquid effluent to sterilise the liquid effluent.

44. A portable sewage collection system in accordance with claim 40 wherein the system comprises a compressed air circuit that is arranged to provide compressed air to move sewage or liquid effluent about the system.

45. A portable sewage collection system in accordance with claim 42 comprising an air lift pump that is arranged to provide a volume of effluent to the sterilising unit, wherein the volume of effluent is small to ensure the flush volume is 1 liter or less.

46. A portable sewage collection system in accordance with claim 45 wherein the volume of sterilised effluent is low enough such that the aerobic bacteria is not killed due to excessive sterilised effluent.

47. A portable sewage collection system in accordance with claim 42 comprising a power generation means being arranged to generate electricity to activate the sterilising unit, wherein the power generation means comprises an air motor being connected to an alternator, the air motor being activated when the toilet pan is flushed, the air motor turning the alternator to generate electricity.

48. A portable sewage collection system in accordance with claim 40 wherein the toilet pan is connected to a venturi, the venturi being arranged to create a vacuum to evacuate the contents of the toilet pan.

49. A portable sewage collection system in accordance with claim 40 wherein the toilet pan is positioned at 100 mm or less than 100 mm above ground level when in use.

50. A sewage collection system comprising a cubicle arranged to mount a toilet and receive a user, the cubicle comprising three walls and an openable door, the cubicle being fully enclosed once the door is closed in order to provide the toilet user privacy while using the toilet.

51. A sewage collection system in accordance with claim 50, wherein the system further comprises a frame arranged to enclose the cubicle, the frame comprising one or more removable panels forming one or walls.

52. A sewage collection system in accordance with claim 35 comprising a toilet arranged to be used by a user, the toilet comprising a flush system, the water from the flush system being recycled through the sewage processing system and reused by the flush system.

53. A sewage collection system in accordance with claim 35 comprising a frame, the frame defining an operational space and a collection space, the operational space comprising a cubicle arranged to house a toilet and receive a user, the collection space arranged to house a sewage processing system
